(19) United States
(12) Patent Application Publication
(10) Pub. No.: US 2024/0100795 A1
(43) Pub. Date: Mar. 28, 2024

(54) APPARATUS AND METHOD FOR THE PRODUCTION OF ITEMS OF CLOTHING AND THE LIKE

(71) Applicant: REGENSTECH S.R.L. SOCIETA' BENEFIT, Ravenna (IT)

(72) Inventor: Maria Silvia PAZZI, Ravenna (IT)

(21) Appl. No.: 18/250,786

(22) PCT Filed: Mar. 8, 2021
(86) PCT No.: PCT/EP2021/055714

§ 371 Date: Apr. 27, 2023

(30) Foreign Application Priority Data
Oct. 29, 2020 (IT) 102020000025666

(51) Int. Cl. B29D 99/00; B09B 3/35; B29B 7/22; B29B 17/00; B29B 17/04; B29C 64/141; B29C 64/209; B29C 64/245; B33Y 10/00; B33Y 30/00; B33Y 40/10; B33Y 80/00

(52) U.S. Cl. CPC B29D 99/0064; B09B 3/35; B29B 7/22; B29B 17/0042; B29B 17/0404; B29B 17/0412; B29C 64/141; B29C 64/209; B29C 64/245; B33Y 10/00; B33Y 30/00; B33Y 40/10; B33Y 80/00; B09B 2101/85

(57) ABSTRACT

An apparatus for the production of items of clothing, which includes at least one shredder, at least one pulverizer, at least one mixer for the mixing of the powder that originates from the pulverizer with at least one other substance chosen preferably from a solvent, polyethylene glycol, and a polyether and organic binders, with consequent obtainment of a mixture. The apparatus also includes at least one extruder of the mixture, which is arranged on a movement unit with at least two axes, for the deposition of layers of the mixture on a predefined surface, with consequent provision of at least one portion of an item of clothing and the like according to a method of the type of additive manufacturing.

### CROSS-REFERENCE TO RELATED APPLICATIONS

This application is a 35 U.S.C. § 371 National Stage patent application of PCT/EP2021/055714, filed on 8 Mar. 2021, which claims the benefit of Italian patent application 102020000025666, filed on 29 Oct. 2020, the disclosures of which are incorporated herein by reference in their entirety.

### TECHNICAL FIELD

The present disclosure relates to an apparatus and a process for the production of items of clothing and the like.

In particular, the present disclosure relates to an apparatus and a process which, starting from waste material, makes it possible to produce clothing, shoes, accessories for clothing (such as for example bags, wallets, scarves, hats) and the like.

### BACKGROUND

It is known to use waste to manufacture some types of clothing: in particular, by recycling polyester or polyethylene waste it is possible to obtain yarns which can be supplied to the textile industry for the production of new fabrics which can be used to provide items of clothing.

All known methods for recycling these waste materials entail the involvement of separate industrial facilities at which only some operations are performed (with particular reference to what has been described above, there is a first facility which converts the waste material into granules of standard size, a second facility in which the yarns and the textile fibers are provided starting from the granules, a third facility for the weaving of the yarns and of the textile fibers, and a fourth facility for the production of items of clothing).

It is noted that in addition to the costs linked to the recycling operations, there are also costs for the transport of the intermediate products from one facility to the other, such transport furthermore causing a significant environmental impact.

Furthermore, it should be specified that known methods provide for recycling for reintroduction into the textile production cycle exclusively of some specific materials, excluding the vast majority of the materials used in the field of clothing and of the associated accessories.

### SUMMARY

The aim of the present disclosure is to solve the problems described above, proposing an apparatus and a process for the production of items of clothing and the like which do not require costs for the transport of the material from one production facility to another.

Within this aim, the disclosure proposes an apparatus and a process for the production of items of clothing and the like that ensure minimal energy consumption and minimal environmental impact.
the disclosure also proposes an apparatus and a process for the production of items of clothing and the like that can operate by using as raw material any item of clothing and/or clothing accessory previously supplied as waste.
the disclosure further proposes an apparatus and a process for the production of items of clothing and the like that can operate by using as raw material any reject of the clothing industry, and/or of the leather industry, and/or of tanneries, and/or of the textile industry.

The disclosure also proposes an apparatus and a process for the production of items of clothing and the like suitable for the production of products which in turn can be recycled.

The present disclosure further provides an apparatus and a process for the production of items of clothing and the like at low costs which is relatively simple to provide in practice and safe in application.

This aim and these and other advantages that will become more apparent hereinafter are achieved by providing an apparatus for the production of items of clothing and the like, characterized in that it comprises
at least one shredder of a type preferably chosen from blade crushers, impact mills, ball mills, and the like;
at least one pulverizer of the type preferably chosen from ball mills, fluid bed mills, ring and roller mills, and the like, for the fine pulverization of the milled material that originates from said at least one shredder;
at least one mixer for the mixing of the powder that originates from said at least one pulverizer with at least one other substance chosen preferably from a solvent, polyethylene glycol, a polyether and organic binders, with consequent obtainment of a mixture;
at least one extruder of said mixture, which is arranged on a movement unit with at least two axes for the deposition of layers of said mixture on a predefined surface, with consequent provision of at least one portion of an item of clothing and the like according to a method of additive manufacturing.

This aim and these advantages are further achieved by providing a process for the production of items of clothing and the like which includes the following steps:
shredding a raw material constituted by at least one material chosen from waste fabrics, overproduction and/or inventory leftovers, rejected items of clothing, rejected hides, rejected clothing accessories and the like in order to obtain a milled material with a particle size distribution comprised between 3 and 10 mm, i.e., with a predominant dimension of each granule comprised between 3 and 10 mm;
subjecting to pulverization a milled material, which originates from the preceding shredding step, in order to obtain a powder with a particle size distribution comprised between 1 and 20 μm, i.e., with a predominant dimension of each powder grain comprised between 1 and 20 μm;
mixing said powder that originates from said at least one pulverizer with at least one other substance chosen preferably from a solvent, polyethylene glycol, a polyether and organic binders, with consequent obtainment of a mixture;
depositing layers of said mixture on a predefined surface, with consequent provision of at least one portion of an item of clothing and the like, according to a method of the type of additive manufacturing.

### BRIEF DESCRIPTION OF THE DRAWING

Further characteristics and advantages of the disclosure will become more apparent from the description of a preferred but not exclusive embodiment of the apparatus and of the process for the production of items of clothing and the like, illustrated by way of non-limiting example in the accompanying drawings, wherein:

FIG. 1 is a schematic view of a possible structure of an apparatus according to the disclosure.

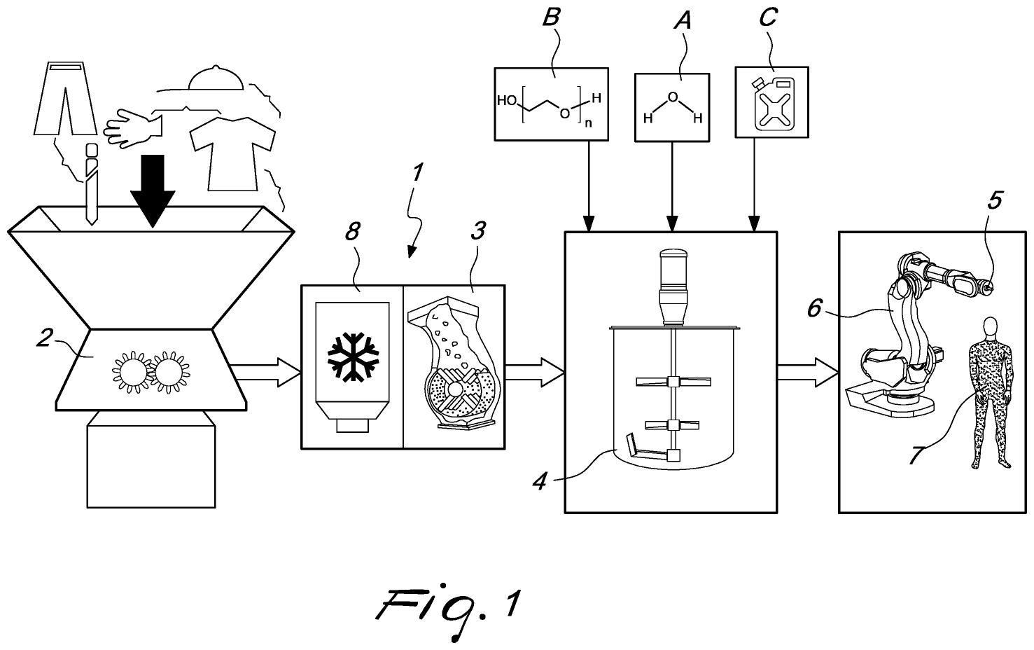

### DETAILED DESCRIPTION OF THE DRAWING

With particular reference to the FIGURE, the numeral 1 generally designates an apparatus for the production of items of clothing and the like.

The expression “items of clothing” is to be understood as referencing any garment and/or any part thereof (starting from parts of the garment such as sleeves, yokes, collars, bodices and the like to include also buttons, decorations and the like).

The apparatus 1 according to the disclosure comprises at least one shredder 2 of the type chosen preferably from blade crushers, impact mills, ball mills, and the like.

Blade crushers or blade mills are devices used to comminute the material introduced into them by virtue of the action of a plurality of blades (generally associated with at least one respective rotating shaft) which cut each individual portion of material until a predefined degree of particle size distribution is reached.

Impact mills or hammer mills are in practice an equivalent to a quarry crusher, with the difference that the one that is used is on a smaller scale. They are constituted by a predefined number of hammers which are fixed to a rotor and are arranged at regular angular intervals. Feeding occurs from above and the crushed material exits from the underlying part. The material, once it has descended from the feeder inlet, is subjected to the impact with the hammers, which push it against the plates which are fixed and are adjusted at a precise distance from the rotating hammers. The impact with the plates causes a further crushing of the material. The material then undergoes two more successive crushings, by means of the compression/friction that occurs when the material passes in the space comprised between the hammers and the two plates. The material then undergoes a series of consecutive crushing processes and the size of the final product is limited by the distance between the hammers and the plate in which the last impact occurs. Finally, the crushed material exits from the underlying outlet.

Ball mills are a type of mill used to mill materials into very fine powder: this is an axially symmetrical apparatus used to mill materials of various kinds. Ball mills of the gravity type rotate about a horizontal axis and are partially filled with the material to be shredded and with the balls, which can be diverse, such as marbles made of ceramic, flint pebbles and steel balls. A cascade effect occurs internally which reduces the material to very fine powder. Industrial ball mills can operate continuously, fed from one side and emptied from the other.

In addition to the ordinary ball mill there is a second type known as planetary ball mill which is used mainly in laboratories for the milling of samples of materials to very small sizes. A planetary ball mill is constituted by at least one container for milling which is arranged eccentrically on a sun gear, the direction of motion of which is opposite the one of the containers for milling. The balls in these milling containers are subjected to superimposed rotary motions, which are called Coriolis forces. The difference in speed between the balls and the containers produces an interaction between the friction forces and the impact forces, releasing energies with high dynamics, producing a high and very effective degree of reduction of the size of the planetary ball mill.

The adoption of additional and distinct apparatuses as shredders 2 is not excluded, as long as they have characteristics and performance that are equivalent to those of the previously cited “mills”.

The apparatus 1 according to the disclosure further comprises at least one pulverizer 3 of the type chosen preferably from ball mills, fluid bed mills, ring and roller mills and the like, for the fine pulverization of the milled material that arrives from the at least one shredder 2.

Ball mills have already been described and reference is made to the definition provided above (specifying that in the present description the definition “ball mill” is considered to include both ball mills of the traditional type and planetary ball mills).

In fluid bed mills the milling is provided by striking the material with concentric jets of air/nitrogen at high pressure. In this manner the friction of the product is utilized and its particles rub against each other, producing finely pulverized material. These mills provide an integrated separator with variable rotation, which is used to screen the material in output and for automatic recycling of the product until the desired particle size distribution is obtained.

Ring and roller mills are essentially constituted by a welded steel frame on which the rollers are mounted on massive cast iron supports. Each pair of rollers is constituted by a fixed cylinder and by a movable one which is retained by springs, in order to allow the passage without damage of any harder foreign objects, with the possibility to adjust the distance in order to vary the final milling size. Control is performed by a speed reduction gearmotor, which transmits motion to the fixed roller with a chain. In turn, the fixed roller transmits the movement to the movable roller by means of a pair of milled steel gears with an elongated set of teeth. The rollers are kept clean by combs or scraper blades and are protected by metal plate housings.

The adoption of additional and distinct apparatuses as pulverizers 3 is not excluded as long as they have characteristics and a performance equivalent to those of the previously cited “mills”.

The apparatus 1 according to the disclosure comprises, downstream of the at least one pulverizer 3, at least one mixer 4 for mixing the powder that arrives from the at least one pulverizer 3 with at least one other substance chosen preferably from a solvent A, polyethylene glycol B, a polyether and organic binders C, consequently obtaining a mixture.

It is specified that the solvent A suitable for numerous applications is water.

In particular, particular levels of purity of the water used as solvent A are not required and therefore it is possible to reuse the water that has already taken part in previous processing cycles, simply by subjecting it to appropriate filtering operations (purification and/or distillation are not necessary): it is therefore demonstrated that the apparatus 1 according to the disclosure does not have an environmental impact in view of the limited water consumption.

The polyethylene glycol B is preferably of the type known as PEG 400 and has a lubricating function. In relation to some possible embodiments, it is noted that polyethylene glycol B can give the finished product (provided with the mixture prepared by the mixer 4) greater flexibility and even a certain elasticity.

In general, the polyethylene glycol B has average molecular weight values comprised between 300 and 10,000,000 g/mol.

The physical properties of the polyethylene glycol B (such as for example viscosity) vary according to the average length of the macromolecules, i.e., according to the average number n of repetitive units, while the chemical properties remain substantially unchanged.

For low values of n, the polyethylene glycol B is liquid, whereas as n increases it instead acquires the appearance of a waxy solid that has a relatively low melting point.

The polyethylene glycol B is soluble in water, methanol, benzene, dichloromethane. It is combined with hydrophobic molecules in order to produce non-ionic surfactants.

The melting point of solid PEGs is around 68° C.

The organic binders C can be constituted by starches or cellulose binders which can originate from waste material of the agroalimentary sector.

Starch is an organic compound of the carbohydrate class, commonly contained in foods such as bread, pasta, rice, potatoes, characterized by a large number of polymerized units of glucose mutually joined by an α-glycosidic bond and constituted by ⅘ amylopectin and ⅕ amylose.

Among cellulose binders, mention is made by way of non-limiting example of the use of hydroxyethylcellulose in a 4% water-based solution. Hydroxyethylcellulose is a cellulose derivative that differs from cellulose in that the hydroxyl groups of the polymer have been replaced by hydroxyethyl groups, which prevent it from crystallizing. It is highly hydrophilic and has thickening and gel-forming properties.

It can be more or less water-soluble depending on the length of the polymeric chains of which it is constituted.

Finally, the apparatus 1 according to the disclosure comprises at least one extruder 5 of the mixture (which originates from the at least one mixer 4 arranged upstream) arranged on a movement unit 6 with at least two axes for the deposition of layers of the mixture on a predefined surface 7, with consequent provision of at least one portion of an item of clothing and the like, according to a method of the type of additive manufacturing.

The extruder 5 makes it possible to provide various types of product, by virtue of the extrusion of the mixture according to a predefined deposition criterion (determined by means of specific calculation algorithms) In particular, for the fashion sector it is straightforward to provide two different types of products, i.e.:
small components (buttons, buckles and other accessories for clothing and leather goods);
larger textile components (contoured fabrics, zip fasteners, etc.).

An implementation is currently provided by means of which it is possible to provide a finished item of clothing without stitched seams or components made of other materials.

The movement unit 6 with at least two axes can be a traditional movement assembly in use in the industry (in this case, the number of movement axes may be selected within a very wide range) or an anthropomorphic robot.

The adoption of anthropomorphic robots makes it possible to bring the extruder into alignment with any part of the predefined surface 7 (which can have any three-dimensional shape), i.e., by rotating about a template (which can be a shape or a mannequin that simulates the body of the customer).

If one decides to adopt an anthropomorphic robot as a movement unit 6, a dedicated extrusion head (extruder 5) is designed which is capable of providing both rigid and flexible products by additive manufacturing for applications in various sectors. The purpose of the apparatus 1 is in fact the production of a wide variety of products that are different in shapes, dimensions, characteristics and functions.

The apparatus 1 according to the disclosure operates in the field of additive manufacturing: it is intended to acquire specialized services in the field of additive manufacturing in order to be able to provide products for various sectors by using an innovative circular material. This innovative material can advantageously be a compound provided by means of recycled textile fibers and organic binders C. By virtue of said material it is possible to help to reduce significantly the waste of the fashion industry and therefore CO2 emissions.

By means of additive production it is possible to provide flexible products for various applications.

Sustainability is increasingly a distinctive element in order to obtain a competitive advantage both in Italy and abroad.

The innovative composite material provided by recycling textile fibers of the fashion sector (treated and produced by the apparatus 1 according to the disclosure) makes it possible to intervene according to environmental protection criteria in a sector that is among the most polluting in the world (the fashion sector): these materials, if not recycled, would be destined to disposal in a landfill.

According to the principles of circular economy, waste is no longer a cost but becomes a new resource to be reintroduced in the production cycle of the production chain. Furthermore, the recycling of the textile and tannery fibers reduces considerably the consumption of water and energy for the production of the raw material, reducing the emission of CO2 into the air.

This apparatus 1 according to the disclosure, by means of the acquisition of specialized services, seeks to provide a customized extruder 5 that is capable of processing the material described above by using anthropomorphic robots (or other multiple-axis movement units 6).

With particular reference to a constructive solution of unquestionable interest in practice and in application, the at least one pulverizer 3 can advantageously be associated with a refrigeration unit 8 for maintaining the at least one pulverizer 3 and its content at temperatures lower than −50° C.

It is specified that as the temperature decreases the fragility of the milled material that originates from the at least one shredder 2 increases, and therefore said material can be pulverized more easily, in order to obtain very low particle size distribution values.

In particular, the refrigeration unit 8 can conveniently comprise a circuit for the recirculation of liquid nitrogen along the at least one pulverizer 3, in order to keep said at least one pulverizer and its content at temperatures lower than −150° C.

It is specified that optimum results have been achieved in terms of particle size distribution of the powder obtained by the pulverizer 3 if the refrigeration unit 8 keeps the pulverizer 3 and its content at a temperature no higher than −200° C., if the pulverizer 3 is a ball mill.

In any case, it is not excluded that additional and distinct ideal operating temperatures might be identified when adopting pulverizers 3 that are different in terms of size, shape (for example planetary ball mills) or type (for example by using fluid bed mills, in which the introduced fluid jets themselves may be at a specific low temperature, or ring and roller mills).

It is specified that the at least one shredder 2 is suitable for crushing material chosen from fabrics, hides and the like to obtain a milled material with a particle size distribution comprised between three 3 and 10 mm, i.e., with a predominant dimension of each granule comprised between 3 and 10 mm.

With particular reference to a possible constructive version of unquestionable practical interest, it is specified that the milled material obtained in output from the shredder 2 can advantageously have a particle size distribution comprised between 5 and 8 mm, i.e., with a predominant dimension of each granule comprised between 5 and 8 mm.

The material chosen from fabrics, hides and the like predominantly originates from the recycling of used and/or defective clothing and accessories, from processing waste of the clothing and accessory manufacturing industry, from processing waste of the leather manufacturing industry and the like (comprising shoe manufacturers), from waste of the textile industry, from waste of the tanning industry and, as a general rule, from all waste of fabrics and textile fibers (natural and synthetic) and from all hide waste.

The possibility is not excluded to be able to use polymeric waste that originates from different sectors, as long as these polymers have chemo-physical properties suitable for the provision of items of clothing and associated accessories (or other types of products that one intends to produce with the apparatus 1 according to the disclosure).

It is specified furthermore that the at least one pulverizer 3 is suitable for the pulverization of a milled material that originates from the at least one shredder 2 in order to obtain a powder with a particle size distribution comprised between 1 and 20 μm, i.e., with a predominant size of each powder grain comprised between 1 and 20 μm.

With particular reference to a possible constructive version of unquestionable practical interest, it is specified that the powder obtained in output from the pulverizer 3 may advantageously have a particle size comprised between 4 and 12 μm, i.e., with a predominant size of each granule comprised between 4 and 12 μm.

It is specified furthermore that the at least one mixer 4 can usefully be controlled by a respective control unit adapted to define a suitable rule of motion for the rotations of the shaft that supports the mixing blades.

The rule of motion will comprise at least one first time interval with mixing rotations at at least one first speed and at least one second time interval with mixing rotations at at least one second speed for the elimination of any foams and the reduction of the emulsified air within the mixture.

More specifically, the mixer 6 makes it possible to create the mixture by eliminating both the area initially incorporated therein and the foam that might form, by virtue of particular rotation modes (called mixing and defoaming modes), thus making it possible to obtain a uniform mixture without agglomerations of fibers which would compromise the subsequent molding step (through the extruder 5).

For example, it is possible to introduce in the container of the mixer 6 first the liquid parts of the formulation (for example polyethylene glycol B and organic binder C) to then add progressively the fibers in powder form until the desired proportion is reached. The solvent A (for example water) can be added beforehand and/or afterwards, depending on the specific requirements requirements of the materials that constitute the fibers in powder form.

Some tests have shown that the mixing rotations might occur effectively at a rate of 900 rpm, while the defoaming rotations might occur effectively at a rate of 1200 rpm (the adoption of different speed values, depending on the specific raw materials introduced in the container of the mixer 6, on the respective quantities, on the overall dimensions of said container and on the characteristics of the mixing blades in use, is in any case not excluded). The two steps might last, by way of indication, 30 seconds each (although it is not excluded to provide longer mixing times in the case of specific applications).

It is specified furthermore that the movement unit 6 may advantageously be constituted by an anthropomorphic robot which is arranged so as to face and be proximate to the predefined surface 7 on which the layers of mixture are to be deposited by means of the extruder 5. The degrees of freedom of the anthropomorphic robot allow effectively the alignment of the extruder 5 with each individual part of the surface 7 (which might also be constituted by a mannequin or by a cast which has exactly the measurements of the customer for whom the item of clothing and/or the accessory is being produced).

The present disclosure extends its protection also to a process for the production of items of clothing and the like that provides for the execution of a series of consecutive steps.

During a first step it is necessary to subject to shredding a raw material constituted by at least one material chosen from waste fabrics, overproduction and/or inventory leftovers, rejected items of clothing, rejected hides, rejected clothing accessories and the like to obtain a milled material with a particle size distribution comprised between 3 and 10 mm, i.e., with a predominant dimension of each granule comprised between 3 and 10 mm.

With particular reference to a possible embodiment of unquestionable practical interest, it is specified that the obtained milled material can advantageously have a particle size comprised between 5 and 8 mm, i.e., with a predominant size of each granule comprised between 5 and 8 mm.

During a subsequent step it will be necessary to subject to pulverization the milled material that originates from the preceding shredding step, in order to obtain a powder with a particle size distribution comprised between 1 and 20 μm, i.e., with a predominant size of each powder grain comprised between 1 and 20 μm.

With particular reference to a possible constructive version of unquestionable practical interest, it is specified that the powder obtained may advantageously have a particle size distribution comprised between 4 and 12 μm, i.e., with a predominant size of each granule comprised between 4 and 12 μm.

One must then proceed with mixing the powder that originates from the pulverization step with at least one other substance chosen preferably from a solvent A, polyethylene glycol B, a polyether and organic binders C, obtaining a mixture.

Finally, one can then deposit layers of said mixture on a predefined surface 7, consequently providing at least one portion of an item of clothing and the like, according to a method of the type of additive manufacturing.

It is specified that the step of pulverization of the milled material can advantageously occur at a temperature lower than −50° C., preferably even at lower temperatures, for example on the order of −200° C.

It is specified that the predefined surface 7 can conveniently be a mannequin which reproduces at least one part of a human shape, for the deposition of the layers of mixture thereon, with consequent shaping of the at least one portion of an item of clothing being provided.

It is specified that the process also comprises a terminal step of drying the layers on the predefined surface 7.

Before the drying step, the mixture has a composition from an initial composition which comprises by way of indication:
powder that originates from the pulverization step, having a percentage by weight comprised between 20% and 60%,
solvent A having a percentage by weight comprised between 30% and 70%,
organic binders C having a percentage by weight comprised between 1% and 10%,
at least one substance chosen from polyethylene glycol B and a polyether having a percentage by weight comprised between 1% and 15%.

At the end of the drying step, the mixture layered on the surface 7 will instead comprise:
powder originating from the pulverization step having a percentage by weight comprised between 75% and 98%,
solvent A having a percentage by weight of less than 2%,
organic binders C having a percentage by weight comprised between 2% and 20%,
at least one substance chosen between polyethylene glycol B and a polyether having a percentage by weight of less than 2%.

By virtue of additive manufacturing it has been possible to identify a production process that is innovative and sustainable, since it does not generate waste and is scarcely energy-consuming, providing, moreover, for extrusion at room temperature. Furthermore, it is possible to provide highly customized products, not only single parts but also small and even large series.

The technology developed by means of the process and by means of the apparatus 1 makes it possible to provide products which are sustainable because they in turn are recycled and can be recycled.

Advantageously, the present disclosure solves the problems described above, proposing an apparatus 1 and a process for the production of items of clothing and the like which do not require costs for the transport of the material from one production facility to another.

The apparatus 1 in fact locates in a single environment the machines required to recycle the raw materials and those required for the provision of the finished product, arranging them in a cascade arrangement.

Conveniently, the apparatus 1 and the process according to the disclosure ensure minimal energy consumption and minimal environmental impact, as described previously.

Usefully, the apparatus 1 and the process according to the disclosure can operate by using as raw material any item of clothing and/or clothing accessory previously supplied as waste.

Positively, the apparatus 1 and the process according to the disclosure can operate by using as raw material any waste of the clothing industry and/or of the leather industry and/or of the tanning sector and/or of the textile industry.

Favorably, the apparatus 1 and the process according to the disclosure are suitable for the provision of products which in turn are recyclable.

Validly, the apparatus 1 and the process according to the disclosure are relatively simple to provide in practice and low-cost: these characteristics render the apparatus 1 and the process according to the disclosure innovations of assured application.

The disclosure thus conceived is susceptible of numerous modifications and variations, all of which are within the scope of the appended claims; all the details may furthermore be replaced with other technically equivalent elements.

For example, it is specified that the apparatus 1 according to the disclosure might also be used to treat similar waste raw materials originating from other sectors (for example the internal linings of demolished vehicles, furniture components, home fabrics, curtains, fitted carpets and coverings, industrial waste, polymeric waste from packaging and the like) for the provision of products intended also for sectors other than the clothing sector, while maintaining the same production logic.

In the exemplary embodiments shown, individual characteristics, given in relation to specific examples, may actually be interchanged with other different characteristics that exist in other exemplary embodiments.

In practice, the materials used, as well as the dimensions, may be any according to the requirements and the state of the art.

1-11. (canceled)

12. An apparatus for the production of items of clothing, comprising
at least one shredder of a type preferably chosen from blade crushers, impact mills, ball mills;
at least one pulverizer of the type preferably chosen from ball mills, fluid bed mills, ring and roller mills, for fine pulverization of the milled material that originates from said at least one shredder;
at least one mixer for mixing powder that originates from said at least one pulverizer with at least one other substance chosen preferably from a solvent, polyethylene glycol, a polyether and organic binders, with consequent obtainment of a mixture;
at least one extruder of said mixture, which is arranged on a movement unit with at least two axes for deposition of layers of said mixture on a predefined surface, with consequent provision of at least one portion of an item of clothing according to a method of the type of additive manufacturing.

13. The apparatus according to claim 12, wherein said at least one pulverizer is associated with a refrigeration unit in order to keep said at least one pulverizer and contents thereof at temperatures below −50° C.

14. The apparatus according to claim 13, wherein said refrigeration unit comprises a circuit for recirculation of liquid nitrogen along said at least one pulverizer, in order to keep said at least one pulverizer and the content thereof at temperatures below −150° C.

15. The apparatus according to claim 12, wherein said at least one shredder is adapted to crush material chosen from fabrics, hides, in order to obtain a milled material with a particle size distribution comprised between 3 and 10 mm, i.e., with a predominant dimension of each granule comprised between 3 and 10 mm.

16. The apparatus according to claim 12, wherein said at least one pulverizer is adapted for the pulverization of a milled material that originates from said at least one shredder in order to obtain a powder with a particle size distribution comprised between 1 and 20 μm, i.e., with a predominant dimension of each powder grain comprised between 1 and 20 μm.

17. The apparatus according to claim 12, wherein said at least one mixer is controlled by a respective control unit that is adapted to define a rule of motion for rotations of a shaft that supports mixing blades of said mixer, said rule of motion comprising at least one first time interval with mixing rotations at at least one first speed and at least one second time interval with mixing rotations at at least one second speed, in order to eliminate any foams and to reduce air emulsified within the mixture.

18. The apparatus according to claim 12, wherein said movement unit is an anthropomorphic robot which is arranged so as to face and be proximate to the predefined surface onto which said layers of mixture are to be deposited by means of said extruder, degrees of freedom of said anthropomorphic robot allowing an alignment of said extruder with each individual part of said surface.

19. A process for the production of items of clothing, the process including the following steps:
shredding a raw material constituted by at least one material chosen from waste fabrics, overproduction and/or inventory leftovers, rejected items of clothing, rejected hides, rejected clothing accessories, in order to obtain a milled material with a particle size distribution comprised between 3 and 10 mm, i.e., with a predominant dimension of each granule comprised between 3 and 10 mm,
subjecting to pulverization a milled material, which originates from the preceding shredding step, in order to obtain a powder with a particle size distribution comprised between 1 and 20 μm, i.e., with a predominant dimension of each powder grain comprised between 1 and 20 μm,
mixing said powder that originates from the preceding pulverization step with at least one other substance chosen preferably from a solvent, polyethylene glycol, a polyether and organic binders, with consequent obtainment of a mixture, and
depositing layers of said mixture on a predefined surface, with consequent provision of at least one portion of an item of clothing, according to a method of the type of additive manufacturing.

20. The process according to claim 19, wherein said step of pulverization of the milled material occurs at a temperature below −50° C.

21. The process according to claim 19, wherein said predefined surface is a mannequin which reproduces at least one part of a human shape for deposition of said layers of mixture thereon with consequent shaping of the at least one portion of an item of clothing that is being provided.

22. The process according to claim 19, further comprising a terminal step of drying said layers of mixture on said predefined surface for a transition from an initial composition of said mixture comprising:
powder originating from the pulverization step, having a percentage by weight comprised between 20% and 60%,
solvent, having a percentage by weight comprised between 30% and 70%,
organic binders, having a percentage by weight comprised between 1% and 10%,
at least one substance chosen between polyethylene glycol and a polyether, having a percentage by weight comprised between 1% and 15%,
to a composition of said mixture stratified on said surface and dried which comprises
powder that originates from the pulverization step, having a percentage by weight comprised between 75% and 98%,
solvent, having a percentage by weight of less than 2%, and
organic binders, having a percentage by weight comprised between 2% and 20%, at least one substance chosen from polyethylene glycol and a polyether, having a percentage by weight of less than 2%.
